(19) United States
(12) Patent Application Publication
(10) Pub. No.: US 2015/0332420 A1
(43) Pub. Date: Nov. 19, 2015

(54) COURT COST MANAGEMENT SYSTEM AND METHOD

(71) Applicant: CARMA LLC, Las Vegas, NV (US)

(72) Inventor: Michelle Shaffer, Las Vegas, NV (US)

(73) Assignee: CARMA LLC, Las Vegas, NV (US)

(21) Appl. No.: 14/713,415

(22) Filed: May 15, 2015

Related U.S. Application Data
(60) Provisional application No. 61/993,841, filed on May 15, 2014.

(51) Int. Cl. G06Q 50/18; G06Q 30/04; G06Q 20/14

(52) U.S. Cl. CPC G06Q 50/18; G06Q 20/14; G06Q 30/04

(57) ABSTRACT

Systems and methods are provided for verification/validation, full and real or near real-time reporting, tracking, and auditing capabilities at varying levels with regard to law firm account management. A centralized management entity can provide a centralized account for reimbursement entities from which payments to law firms/attorney networks can be made. Funds are not actually possessed by law firms and/or attorney networks in direct contrast to conventional systems and methods.

### CROSS-REFERENCE TO RELATED APPLICATIONS

This application claims the benefit of U.S. Provisional Patent Application No. 61/993,841 filed on May 15, 2014, which is incorporated herein by reference in its entirety.

### TECHNICAL FIELD

The present disclosure relates generally to account management. In particular, some embodiments relate to establishing a centralized system that provides dedicated payment and account management, as well as audit and reporting capabilities.

### DESCRIPTION OF THE RELATED ART

Legal services provided by law firms often entail paying various fees associated with the representation of clients. For example, law firms involved in litigation matters may file certain documents with a court during the course of a lawsuit, to initiate a lawsuit, etc. on behalf of a client. Such fees may include, but are not limited to filing a complaint, filing a petition, answering a complaint, etc. Law firms involved in transactional matters may also incur fees associated with the filing of one or more documents with, e.g., a municipal or other governmental agency. Law firms may also incur costs associated with the utilization of services provided by other service providers or vendors. For example, law firms may incur costs associated with the performance of legal and business-related research using tools provided by, e.g., LexisNexis™, Westlaw®, and similar entities.

Because law firms may represent many different clients, the management of costs and payments to the courts or payments received from different entities is onerous and many times ignored due the complexity of the nature and number of financial transactions a law firm may engage in, even on a daily basis. These complications can be exacerbated when considering the various rules and/or regulations law firms must adhere to when handling client-related monies. Moreover, debt owners, banks, credit issuers and the like may utilize attorney networks that act as “middle men” between the law firms and those third party entities, e.g., banks, debt buyers, collection agencies, mortgage companies that file, e.g., bankruptcy and foreclosure documents with courts, file suit to collect debt, and/or other credit issuers. Further still, these third party entities can often be left in the dark as to payments and reimbursements made to/received from law firms in the course of their legal operations, e.g., whether or not a certain payment was utilized for its intended purposes, whether or not the law firm owes money to the third party entity, etc. Law firms as well may be disadvantaged in certain scenarios, where a debt owner may deny reimbursement of some cost(s) already paid out by the law firm, resulting in a monetary loss for the law firm.

### BRIEF SUMMARY OF THE DISCLOSURE

In accordance with one embodiment, a non-transitory computer-readable medium has computer executable program code embodied thereon, the computer executable program code being configured to cause a computer system to perform the following operations: establish and maintain a payor account; receive a request for payment of a legal services-related fee; validate amount of the payment; issue a transaction ID for the payment; and associate the transaction ID with the payment of the legal services-related fee the payment of the legal services-related fee being funded through the payor account.

In accordance with another embodiment, a method comprises transmitting a payment request to a centralized management entity, wherein the payment request is associated with payment of a legal services-related fee. The method further comprises receiving a transaction ID associated with the payment request from the centralized management entity, and issuing a payment mechanism, wherein funds for the payment mechanism are paid out from a reimbursement account of at least one of a debt owner and an attorney network entity, and wherein the payment mechanism is issued only after verification of the legal services-related fee. Further still, the method comprises remitting the payment for the legal services-related fee to a legal service provider providing a service for which the payment of the legal services-related fee is required.

In accordance with yet another embodiment, a system comprises a payment gateway configured to receive a payment request from a requesting entity. The payment gateway is further configured to issue a validated payment mechanism to the requesting entity via at least one of a reimbursement entity and an intermediary, the validated payment being funded by a reimbursement entity account maintained at the system. The system further includes a database comprising relevant fee schedules in accordance with which the validated payment is made for validating an amount of the payment request and tracking information comprising relevant data indicative of and associated with the validated payment mechanism and at least one of the requesting entity, the reimbursement entity, and the intermediary. Additionally still, the system comprises a reporting module configured to track events associated with the validated payment mechanism beginning from receipt of the payment request through issuance of the validated payment mechanism.

### BRIEF DESCRIPTION OF THE DRAWINGS

The present disclosure, in accordance with one or more various embodiments, is described in detail with reference to the following figures. The drawings are provided for purposes of illustration only and merely depict typical or example embodiments. These drawings are provided to facilitate the reader's understanding of various embodiments and shall not be considered limiting of the breadth, scope, or applicability of the present disclosure. It should be noted that for clarity and ease of illustration these drawings are not necessarily made to scale.

FIG. 1 illustrates an example system indicative of conventional account management and payment processing.

FIG. 2 illustrates an example system for account management and payment processing in accordance with various embodiments of the present disclosure.

FIG. 3 is a flowchart illustrating example processes performed for payment processing in accordance with various embodiments of the present disclosure.

FIG. 4 is a flowchart illustrating example processes performed for requesting and remitting payment in accordance with various embodiments of the present disclosure.

FIG. 5A is an example screenshot of a payment request GUI in accordance with various embodiments of the present disclosure.

FIG. 5B is an example screenshot of a check to be issued in accordance with various embodiments of the present disclosure.

FIG. 6 is an example of a computing module that can be used in conjunction with various embodiments of the present disclosure.

The figures are not intended to be exhaustive or to limit various embodiments to the precise form disclosed. It should be understood that various embodiments can be practiced with modification and alteration.

### DETAILED DESCRIPTION

Various embodiments described in the present disclosure are directed toward systems and methods tracking, reporting on, and/or otherwise managing one or more accounts involving financial transactions between a plurality of entities, such as law firms, attorney networks, and credit issuers/banks/debt buyers.

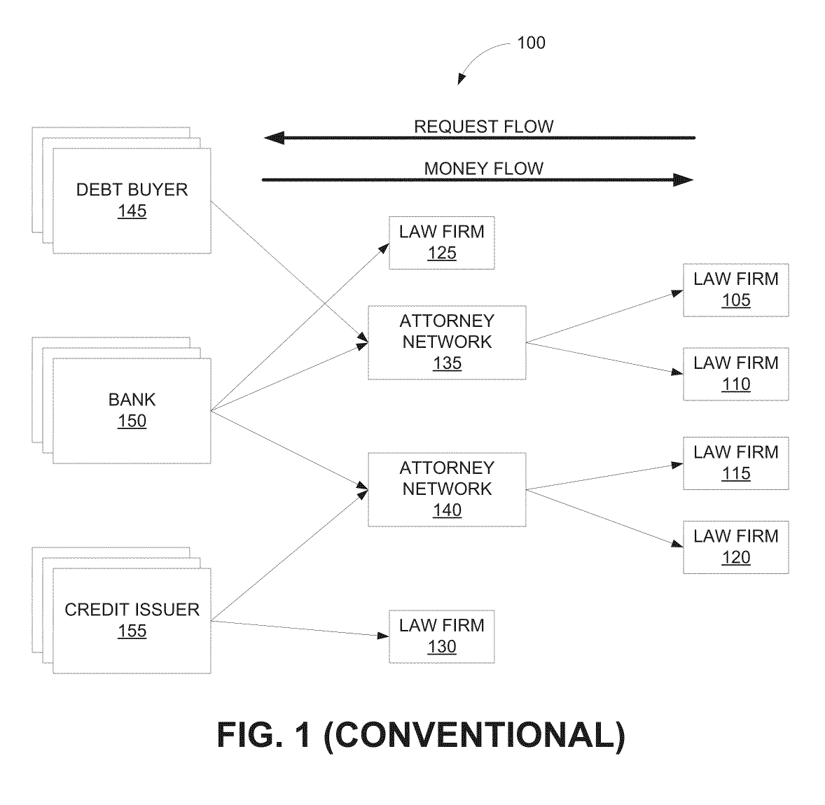

FIG. 1 illustrates an example of a conventional system or network 100 involving the requesting of money and money flow between one or more law firms and various entities. For example, law firms 105, 110, 115, 120, 125, and 130 may incur certain court costs associated with the legal representation of clients, e.g., filing a complaint. That is, each of law firms 105, 110, 115, 120, 125, and 130 may pay certain fees with, e.g., a municipal court, in order to file a complaint. Certain law firms, e.g., law firms 105, 110, 115, and 120 may utilize, what can be referred to “attorney networks” 135 and 140 for reimbursement of those costs. Attorney networks can refer to accounts receivable management organizations that provide, e.g., debt recovery services.

FIG. 1 illustrates attorney networks 135 and 140 acting as intermediaries between law firms 105, 110, 115, and 120 and banks, debt buyers, or other creditors, e.g., debt buyers 145, banks 150, and credit issuers 155. Attorney networks 135 and 140 may then pass these incurred costs onto debt buyers 145, banks 150, and/or credit issuers 155. In certain instances, law firms, such as law firms 125 and 130, may forego use of an attorney network, and directly request reimbursement from, e.g., banks 150 or credit issuers 155.

It should be noted that various relationships can exist between one or more law firms, attorney networks, and debt buyers, banks, and credit issuers. That is, a law firm may utilize an attorney network for the reimbursement of costs associated with certain clients, while obtaining reimbursement directly from a bank for cost reimbursement associated with other clients. As another example, a law firm may have different accounts established and maintained for their various clients which could include attorney networks, debt buyers, and credit issuers at more than one bank or credit issuer.

In conventional systems or networks, such as network 100, reporting on what, e.g., banks, are spending to reimburse law firms is non-existent. This is due, at least in part, to the sheer volume of matters that law firms handle. For example, a single law firm may file a thousand or more lawsuits (each requiring corresponding fees) in a single week. Accordingly, there is minimal, and in some cases, a complete lack of control regarding the outlay of money to law firms for reimbursement of, e.g., court costs, service process costs, etc. Periodic auditing of bank reimbursements can be performed, but is often inadequate for accurately capturing the specifics of the multitudes of transactions that occur. Neither attorney networks, nor the law firms themselves are able to provide accurate reporting to the banks/debt buyers/credit issuers.

To add to the aforementioned complications, law firms may be required to establish and maintain trust accounts for their clients. Some law firms may maintain a separate trust account from which monies may be paid out or received on behalf of a client. Some law firms may maintain a single trust account for all of their clients. In either case, the movement of money in and out of these trust accounts occurs too rapidly to allow for proper and adequate reporting and/or tracking. Accordingly, money moves in and out of these trust accounts without the law firm (or attorney network or bank) being aware of what money has been paid out or received for what service, matter/case, etc. In the case of law firms that utilize a single trust account, it is further unknown, many times, what received money belongs to which client and/or whether a client's money is being used to pay for services for that client or another client, i.e., clients' funds are commingled.

Other law firms may establish an operating account for use as a buffer ahead of one or more trust accounts for the payment or receipt of money. However, and again, the movement of money is simply too rapid to allow for any manner of accurate tracking/reporting. Still other law firms utilize one or more trust accounts as their own operating accounts, which, for at least one or more of the aforementioned reasons, creates disorder and confusion regarding the reporting and/or tracking of money flow. Even attempting to separate trust and operating accounts for each client would not be a practical solution for law firms, as the establishment and maintenance of two separate accounts for each client would be an onerous task as well.

Regardless of how a law firm may address, e.g., court costs, payments for services, etc., whether such payments are made in the form of checks, automated clearing house (ACH) payments, or other forms of electronic payments, errors can arise. For example, such payments may get lost, voided, or otherwise cancelled. This only adds to the confusion described above. Further still, tracking and reporting of the reimbursement for such costs/payments to the law firm from courts or service providers, for example, may also be problematic as currently, there is no reliable method of capturing such reimbursements to the law firm, which can result in debt owners losing money. Hence, entities such as banks, debt buyers, and other credit issuers/unions may often be owed money by a law firm, but due to the aforementioned lack of tracking and reporting, these entities are unaware that they may be due money, or are inadequately equipped to regain that money. This can result in a large amount of lost revenue as some entities may spend upwards of $120 million in court cost reimbursements over a three-year period, according to one study reflective of U.S. Security and Exchange Commission (SEC) filings for a publicly traded debt buyer.

Moreover, and due the confusion associated with law firm reimbursement, some law firms have unscrupulously learned how to “game” the reimbursement entities. For example, a law firm may request reimbursement for a court cost for which the law firm never intends to incur. That is, a law firm may request reimbursement for, e.g., filing a complaint, that the law firm never files. The law firm may funnel the reimbursement money to run operations, and after some time, reverse the costs. Accordingly, the law firm has received an interest-free loan from the reimbursement entity, such as a bank.

In accordance with various embodiments, management systems and methods are provided for centrally managing reimbursements, such as court cost reimbursements for law firms. As a result of centrally managing reimbursements, law firms are no longer burdened with the management of their own reimbursement finances, such as reporting and/or tracking the payment of legal services fees, such as court costs, and the receipt of reimbursement payments for such legal services fees. Furthermore, law firms are prevented from defrauding reimbursement entities, while reimbursement entities can be provided with accurate reporting regarding reimbursements that they pay out.

Additionally, there are rejection of cost reimbursement requests that occur. A law firm may request reimbursement, and a debt owner may deny the request because it is believed to be an erroneous duplicate request. When this happens, the law firm loses money because they have spent money on a cost associated with filing a suit, but the reimbursement is denied.

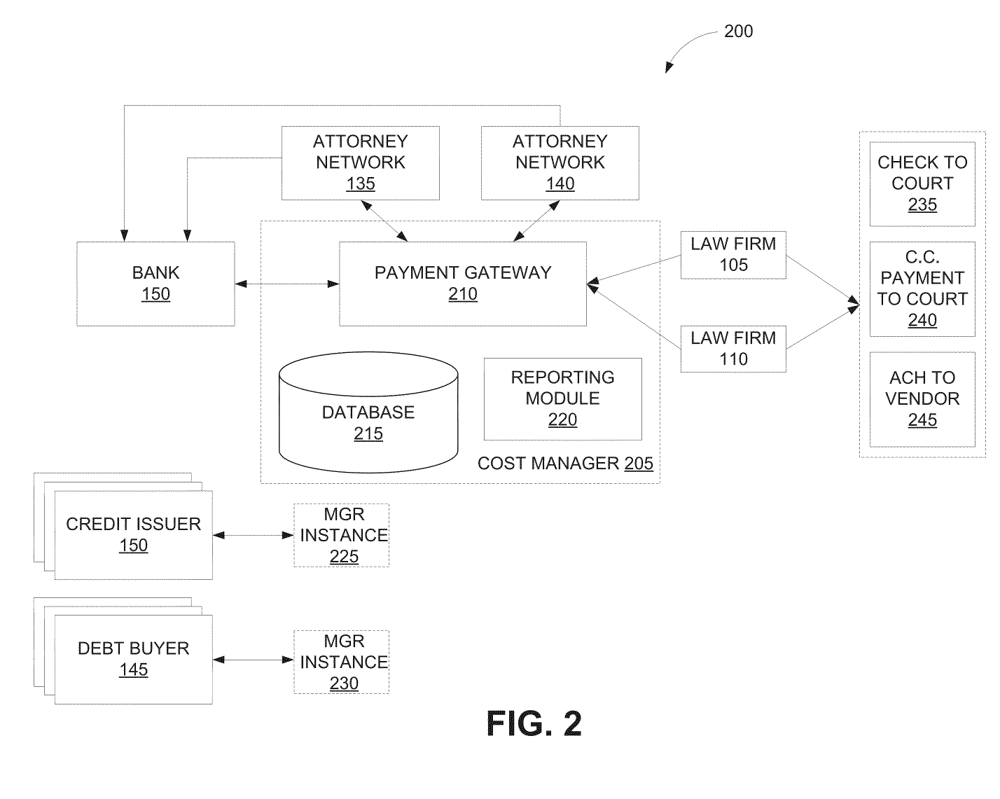

FIG. 2 illustrates an example management system 200 configured in accordance with various embodiments. Central to management system 200 is a cost manager 205. It should be noted that although management system 200 is described herein as being a centralized management system, the term centralized can refer to the aggregation of functionality at a centralized management entity, and not necessarily to the system architecture. For example, cost manager 205 may be implemented at a single location or may be distributed amongst a plurality of locations for, e.g., serving one or more entities at disparate locations.

Management system 200 may include, as alluded to above, a cost manager 205. Cost manager 205 can include a payment gateway 210 through which reimbursements requests can be received, e.g., from law firms 105 and 110. Payment gateway 210 may process the reimbursement requests and interact with an attorney network, such as one or more of attorney networks 135 and 140. Attorney networks 135 and 140 may provide reimbursement to law firms 105 and 110 via payment gateway 210. Alternatively, payment gateway 210 may forward the reimbursement requests from law firms 105 and 110 to attorney networks 135 and 140, thereby allowing attorney networks 135 and 140 to process the reimbursement requests. Attorney networks 135 and 140 may then interact with, e.g., bank 150, to obtain reimbursement for their payment to law firms 105 and 110. Again, payment can be processed at or through payment gateway 210 as will be discussed in greater detail below. Reimbursement entities, such as bank 150 may establish and fund a reimbursement account with the centralized management entity from which reimbursement payments can be paid.

As can be appreciated, control of payments to and from law firms, attorney networks, and/or reimbursement entities can be maintained using a centralized management entity. In this way, the centralized management entity can track and perform reporting on the flow of money through its payment gateway 210, via a reporting module 220. That is, bank 150, for example, can obtain accurate reporting of any reimbursement monies it pays out to an attorney network, e.g., attorney network 135, and ultimately, to a law firm, e.g., law firm 105. In contrast to conventional systems, bank 150 can now be aware of how much money is paid out in requested reimbursements, as well as to what law firm, what matter, what client, etc. The requisite information regarding payment information, law firm information, client information, matter information, etc. can be maintained in database 215. It should be noted that database 215, although illustrated in FIG. 2 as a single database can, in actuality, be a plurality of databases, or a database having multiple partitions.

It should also be noted that cost manager 205 may substantiate or otherwise verify, e.g., requested court costs, by obtaining copies of documents filed with a court(s) associated with a particular request. In this way, reporting module 220 may include, in a report to a client (bank, debt owner, etc.), requested and/or paid out costs for which documents have not been provided by law firms. Certain parameters can be predefined or otherwise configured, such as a certain number of days or months after a requested reimbursement within which such documents should have been provided.

Other manager instances 225 and 230 can be implemented or effectuated. For example, credit issuer 150 can interact with one or more other law firms and/or attorney networks via another manager instance 225. Debt buyer 145 may also interact with one or more other law firms and/or attorney networks via still another manager instance 230. It should be noted that manager instances 225 and 230 can be implemented within the same computer, processor, server, or other computing system in which cost manager 205 is implemented, or at another computer, processor, server, or computing system at and/or controlled by the centralized entity.

As also illustrated in FIG. 2, reimbursement payments that can be made by a law firm, e.g., law firms 105 and 110, can be in the form of checks 235 (to a court, for example), a credit card payment 240 to a court, and/or an automated clearing house payment 145 to, e.g., a vendor (or any other type of appropriate physical or electronic payment method). It should be noted that various embodiments contemplate utilizing appropriate security and authentication/authorization measures associated with any contemplated payment methods.

Cost manager 205 can be implemented at one or more servers, processors, computing systems, etc., at or controlled by the aforementioned centralized entity. Access to cost manager 205 can be effectuated via software, hardware, and/or combination of hardware and software, such as a web-based interface that can be accessed over one or more communications networks via some client device(s). In accordance with another embodiment, cost manager 205 can be a standalone application, for example, that can be run on a client device. Client devices may include any hand-held computing device (tablets, PDA's, smartphones, cellphones, palmtops, etc.); workstations or servers; or any other type of computing device configured to access and/or run an instance of cost manager 205, 225, or 230.

It should be noted that management system 200 may be further operatively connected to one or more collection systems and/or utilize or implement therein collections functionality, existing or proprietary. Examples of existing debt collection software include, but are not limited to CollectMax™ from JST and Collection-Master® from Commercial Legal Software, Inc. Such functionality may be used to allow management system 200 to suspend or temporarily disable the ability of a law firm to enter costs/request reimbursement if a client, e.g., a bank or other debt owner, dictates. Alternatively, management system 200 may connect to an intermediary system (an example being YGC Data Exchange) that can reside in between an attorney network 135,140 or bank 150 and law firms 105, 110. This allows for quick and efficient integration or porting of accounts (e.g., opened by a credit issuer, attorney network, or debt buyer for a law firm) to management system 200, in particular, database 215, for example. Accordingly, management system 200 can upload any costs on a consumer account level basis on behalf of the law firm so that the law firm need no longer manually key in or otherwise enter costs into management system 200 and their own respective collection system(s).

A communications network contemplated in accordance with various embodiments may include, e.g., a cellular telephone network, an ad hoc network, an intranet, an extranet, a virtual private network (VPN), a local area network (LAN), a wireless LAN (WLAN), a wide area network (WAN), a portion of the Internet, a portion of the Public Switched Telephone Network (PSTN), or any combination thereof. Such a communications network may use a number of communication mediums. The communication mediums may be, for example, a wireless network system such as a cellular network, a wireless personal area network, a wireless local area network, or other similar communication medium. The communication medium may alternatively be a wired system, such as a coaxial cable system, a fiber optic cable system, an Ethernet cable system, or other similar communication medium.

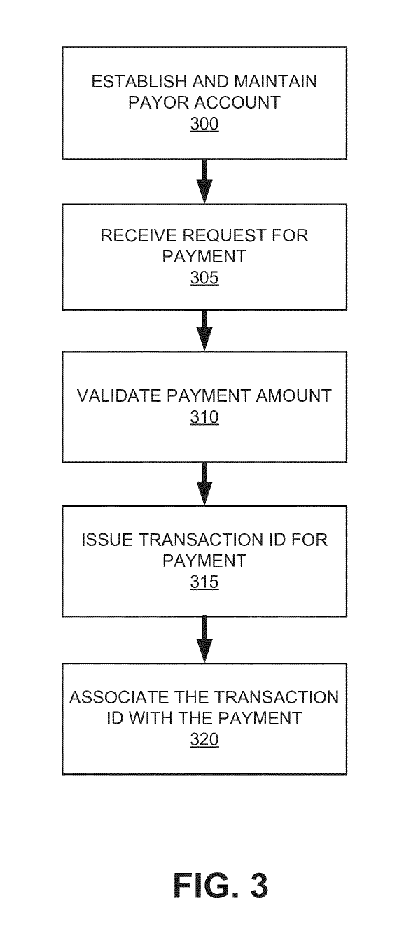

FIG. 3 illustrates a method of reimbursement management in accordance with one embodiment. From a reimbursement entity perspective, e.g., a bank (which may be thought of as a payor), establishes and maintains a payor account at operation 300. As described above, a bank can establish and fund an account with the centralized management entity. Payments made to an attorney network and/or a law firm can be funded by such a payor account.

The bank may receive a request for payment at operation 305. For example, a law firm may access the centralized management entity, in particular a manager interface, through which the law firm may request payment for one or more legal or legal-related services, such as filing a complaint with a court. As will be described in further detail below, validation or verification can be implemented by maintaining and/or accessing one or more databases (e.g., database 215 of FIG. 2) that have stored therein, appropriate fees or costs associated with various actions, such as filing a complaint within a particular jurisdiction. In the case of requesting payment to a process server for serving one or more documents to a party, requesting payment for a vendor-provided service, etc., the centralized management entity may require the law firm to provide some form of invoice or other document, information (such as invoice number), etc. that allows the centralized management entity to verify the law firm's request for payment. It should also be noted that the law firm can be given the ability to override a fee associated a particular action. Therefore, the centralized management entity can run exception reports at periodic intervals, e.g., daily, to identify any overrides (exceptions to validated fees), and effect other methods of verifying that the requested amount of payment is commensurate with a provided service/action undertaken or to be undertaken by the law firm. Accordingly, payment amount can be validated at operation 310.

At operation 315, a transaction ID can be issued by the centralized management entity for the requested payment. As described previously, payment can be made via check, ACH payment, credit card payment, or other physical and/or electronic payment method. In the case of check payment, and referring back to FIG. 2, a transaction ID can be generated by payment gateway 210. The transaction ID is then associated with the payment at operation 320. Therefore, and in accordance with one embodiment, the law firm may be given the ability to print a check in an amount commensurate with the requested payment amount (e.g., a validated payment amount). That is, once the transaction ID is generated and associated with a requested payment, payment gateway 210 can provide an option for the law firm to print a physical check for the requested payment amount using, e.g., a magnetic ink character recognition (MICR) printer, upon which the transaction ID is included. In accordance with another embodiment, the law firm may choose to have the centralized management entity print a check remotely, and forward the check to the law firm. The law firm may then remit payment accordingly.

In order to prevent any attempted fraudulent payment requests, the check may be made out to the appropriate court, service provider, etc., rather than to the law firm. In the case of ACH payments, payment gateway 210 may effectuate payment directly to the court, service provider, etc., without further involvement by the law firm, thereby reducing the chance for fraud. In addition, appropriate electronic security measures can be implemented to, e.g., verify the identity of the service provider, verify existence of an invoice, etc. In the case of credit card payment requests, a one-time use credit card number can be provided to the law firm. The generated transaction ID can be utilized as, or in addition to, e.g., a card verification value (CVV) when submitting the credit card payment electronically.

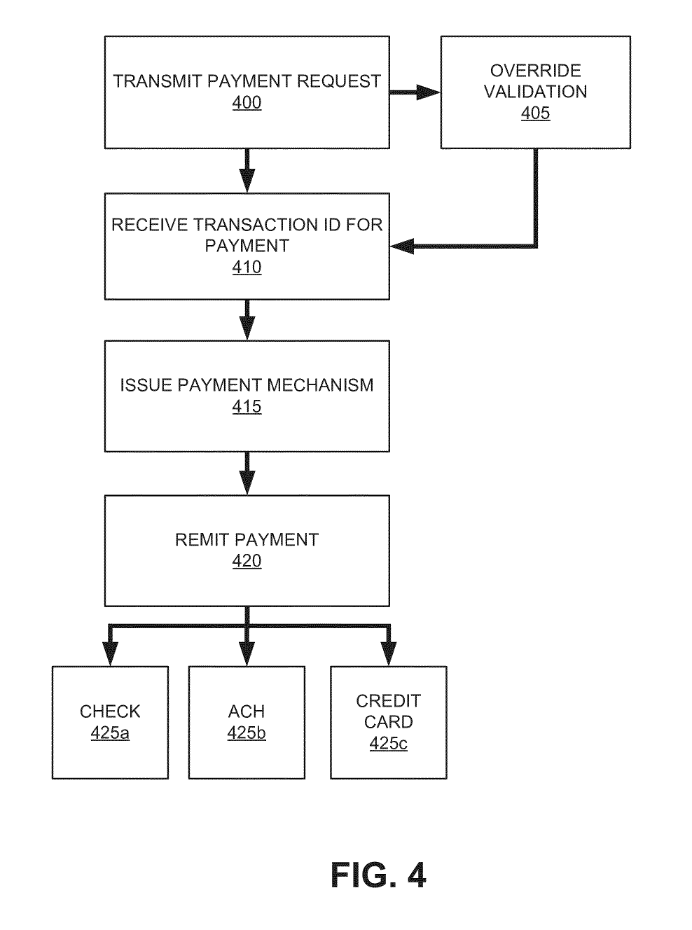

FIG. 4 illustrates a method of reimbursement management in accordance with one embodiment from a law firm (which can be considered a payee) perspective. At 400, the law firm can transmit a payment request to the centralized management entity (i.e., via cost manager 205 of FIG. 2). As described above, the law firm may input a requested payment amount, and cost manager 205 may validate the requested payment amount. Cost manager 205 (in particular, payment gateway 205) can then generate a transaction ID that can be associated with the requested payment at operation 410.

As described above, the law firm may override validation of a requested payment amount at operation 405. This can be the result of database 215, e.g., not having the most up-to-date fee schedule for a particular court or agency, or in the event that the legal service(s) provided or to be provided by the law firm require non-standard measures that require payments that are not normally contemplated. Again, a transaction ID may be generated at operation 410.

As also described above, various payment mechanisms can be requested. For example, the law firm may request a physical check to be printed and sent out (either to the law firm or to a receiving court/service provider). Alternatively, the law firm may print out the physical check itself with the appropriate equipment, such as a MICR check printer, or other check printing/remittance technology. It should be noted that to avoid any impropriety, it is preferable that a payment such as a physical check, are made out to the entity to be paid, rather than the law firm. Alternatively, still, the law firm may request a one-time use credit card number, or an ACH payment to be made. It should be noted that, again, in order to avoid any impropriety, the one-time use credit card number, in accordance with one embodiment, may only be utilized to remit payment (in a specified amount) to the particular court, service provider, etc. associated with the payment request. A time limit may also be implemented for the one-time use credit card number for security purposes. Accordingly, an appropriate payment mechanism is issued at operation 415 in accordance with various embodiments.

Furthermore and because in some embodiments, payments are made/processed to occur between the bank, debt buyer, etc. directly to a court or service provider, law firms can be protected from monetary losses as well. That is, in conventional systems, a law firm may remit payment for court costs or services rendered, and reimbursement for those court costs or rendered services are subsequently denied, resulting in the law firm losing money. In accordance with various embodiments, because payments can be made directly between the court or service provider and, e.g., a debt owner, such law firm losses can be avoided. Moreover, utilization of a system such as that described herein relieves law firms from the burden of advancing their own money for, e.g., court costs, with only a chance for reimbursement by a debt owner (rather than a certainty).

The law firm may then remit payment at operation 420, by whatever payment mechanism was requested or is required. For example, payment may be remitted in the form of a check 425a, an ACH payment 425b, or a credit card payment 425c. It should be noted that various embodiments can be adapted to issue multiple payment mechanisms if necessary. In such a scenario, the generated transaction ID can be associated with multiple payment mechanisms and/or multiple transaction IDs can generated and associated with each other/the payment request.

It should be noted that database cost manager 205 may have built-in intelligence that can operate in conjunction with the aforementioned validation functionality that can alert the law firm to, e.g., acceptable payment methods for payment of a particular fee to a particular entity, jurisdiction, etc., as well as other requirements. For example, database 215 may store filing requirements along with fee schedules. That is, upon transmitting a payment request for a particular action, such as filing a complaint, cost manager 205 may access database 215 to validate the requested payment amount, as well as access any related information to filing a complaint. For example, upon requesting a payment for filing a complaint in a particular jurisdiction, cost manager 205 may alert the law firm that only electronic filings are accepted and that payment must be made electronically. In accordance with various embodiments, the law firm need not specify a requested payment amount, but rather, allow cost manager 205 to determine an appropriate payment amount. As previously indicated, the law firm may override a payment amount presented/suggested by database cost manager 205.

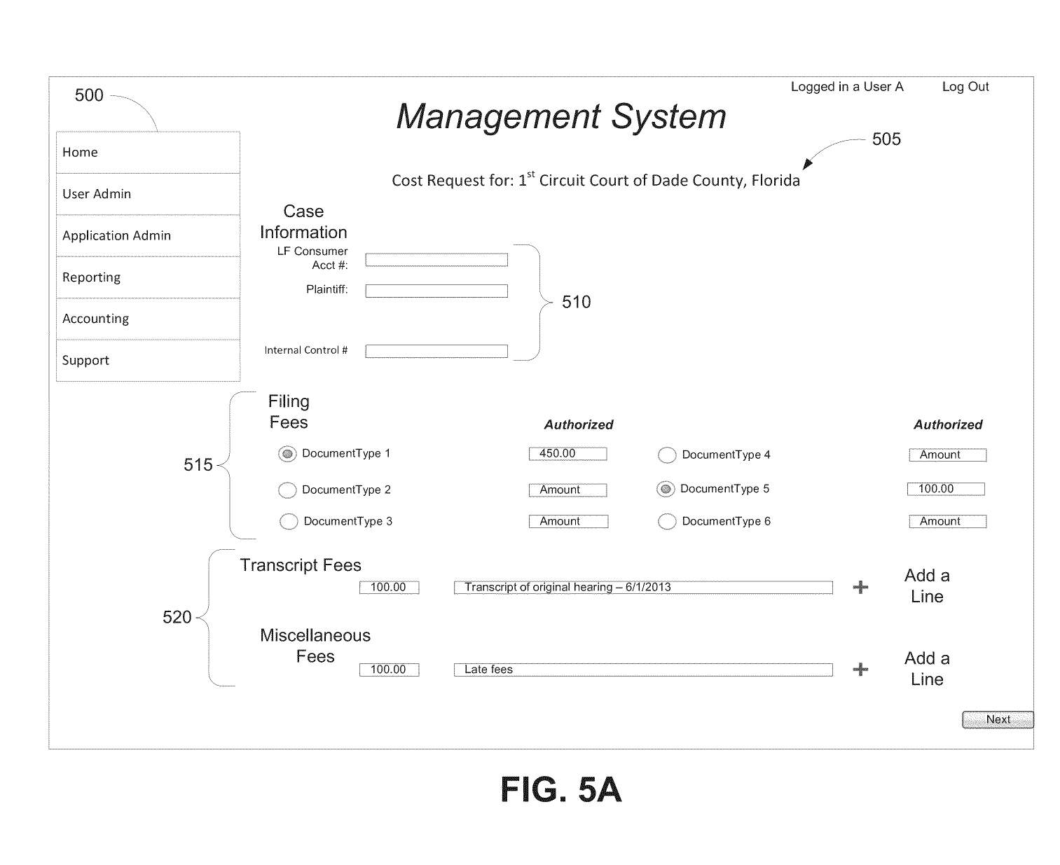

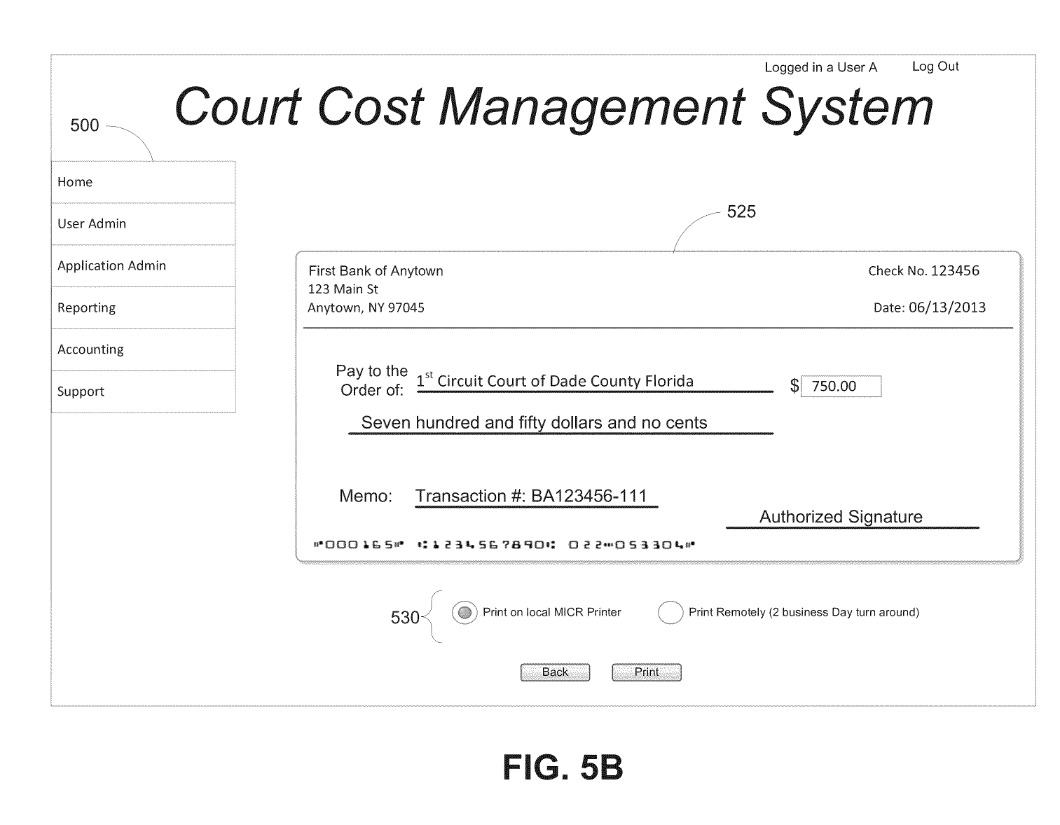

FIG. 5A is a screenshot of an example payment request graphical user interface (GUI) that a law firm may utilize to request payment (reimbursement). The GUI may be presented to a user (e.g., law firm expense administrator) on a display of a client device, such as computer workstation. As previously described, a cost manager (e.g., cost manager 205 of FIG. 2) may be implemented via web-based software, a standalone application running on the computer workstation, or some other appropriate implementation.

The GUI may include a menu 500 that the user may utilize to select various features/functionalities provided by the cost manager. The user may input (via a keyboard, mouse, or some other input mechanism or combination of input mechanisms), or interact with a selective pull-down menu or other mechanism to indicate an appropriate venue, entity, jurisdiction, etc. to or for which payment is requested at field 505. Information associated with and relevant to the case or matter can be input by the user via one or more fields 510. Fields 510 can include a consumer account number, a party name (such as the name of a plaintiff), and an internal control number (which may be a client-matter number assigned to the case/matter by the law firm). It should be noted that more or less fields can be presented to the user for entering more or less relevant case/matter information.

The fees associated with one or more actions, documents to be filed, etc. can be presented to the user via one or more fields 515. As described above, a user may select, input, or otherwise indicate that a particular document is to be filed, and requests an appropriate payment amount that is to be remitted along with the filing or submission of the particular document with the particular entity (identified in fields 505). As also described above, the cost manager may validate the requested payment amount(s) and/or provide a known payment amount associated with the requested document (and action, e.g., filing of the document). Additional fees may be indicated and requested by the user at fields 520, such as transcript fees and/or other miscellaneous fees. The user may input additional fees if necessary.

FIG. 5B illustrates a screenshot of another example GUI for presenting a check image for printing in accordance with various embodiments. As described above, various payment mechanisms may be issued by the cost manager. In the case of a physical check, the GUI may display an image 525 of a check. The check may be automatically populated with the requisite information that can be gleaned from one or more of the fields presented in FIG. 5A and/or other information gleaned from one or more databases containing requisite information, such as a database 215. For example, image 525 shows that the check is to be made to the court identified in field 505 of FIG. 5A, and for the amount requested in fields 515 and 520. The check may be provided with an appropriate signature of the issuing bank, or other reimbursement entity. Additionally, the transaction ID that was generated in associated with the requested payment can be automatically indicated in the check, e.g., in the memo area of the check. The check may also have the appropriate routing/account numbers, such as the reimbursement entity account set up and funded by the reimbursement entity with the centralized management entity. The user may select to print out the check or select an option to have the check remotely printed and forwarded at 530.

The GUI may present additional information to a user, such as a transaction summary screen that, e.g., outlines the information input and/or presented to the user prior to (when a user can select a payment mechanism) or subsequent to issuing a particular payment mechanism. Additionally, the GUI may present an aforementioned one-time user credit card and transaction ID. In accordance with various embodiments, a credit card account can be established, but funded only with payments upon request and, e.g., validation, instead of one-time use credit card accounts.

Additionally, and as described above, various embodiments contemplate allowing a law firm to pay for third party-provided services. Accordingly, various embodiments can process invoiced services in the same or similar manner as that for requested payments described above, or they can be processed independently, via one or more invoice processing GUIs, where relevant information such as vendor name, invoice number, due date, amount due, invoice description, can be input. If invoice documents are required for processing an invoice payment, a mechanism can be provided that allows a user to upload, e.g., copy of the requisite invoice document for validation purposes. Again, a physical check, ACH payment, or credit card account information (along with a transaction ID can be provided) for use by the law firm to remit payment to the vendor.

Therefore, an identifiable, verifiable, and/or otherwise traceable accounting of (reimbursement) payments is created in accordance with various embodiments. As previously described, unique transaction IDs are attached to various payments or steps of a payment process that allow any transactions in a reimbursement context, between any parties involved in a reimbursement process, to be tracked and/or reported. The transaction ID can be associated with one or more relevant types of information, such as a reimbursement entity's (e.g., bank's) internal control number, a law firms matter number, etc. so that tracking and reporting can be provided based on any relevant information that may be input by a user, for ease of record retrieval.

Additionally, and to the above, various GUIs can be provided that present the user with a plurality of information regarding, e.g., accounting/reporting support. For example, a user may select to run a report on a vendor or client, and one or more GUIs can provide an interface allowing the user to request information regarding payments and/or other related records. Accounting support can also provide GUIs that allow the user to enter relevant information regarding clients and vendors, such as relevant account numbers, check routing numbers, etc. It should be noted that this information can be provided to the centralized management entity and automatically populated, or may be input as required by a user.

Reports can be run in accordance with any number of parameters or constraints, such as date ranges, payment amount ranges, transaction IDs, vendor or client name, reimbursement entity, etc. Reports can run at periodic or aperiodic interval. Reports can be run as requested by a user, or automatically, such as at the close of each business day (e.g., in the case of exception reports). It should be noted that the attorney networks and reimbursement entities, in addition to the law firms may access the cost manager and run appropriate reports if desired. That is, users/entities can be set up with one or more accounts in the cost manager. One example of a report is a report that outlines all payment requests requested for a particular law firm client, Comparative reports can be requested, such as a comparison of the aforementioned payment requests requested for a particular client and received reimbursements/issued payments. Other reports can provide information regarding surplus funds associated with a client that require payment return to a reimbursement entity, such as bank or credit issuer. It should be noted that the examples described herein are not meant to be limiting in any way, and that various embodiments contemplate the ability to track and report on any identifiable/determinable information, statistics, etc. as may be required or desired by an entity. Such accounting/reporting/tracking can be performed by, e.g., reporting module 215 of FIG. 2.

Law firms process large volumes of cost transactions, and lack bank account reconciliation, account control and reporting, along with oftentimes-inexperienced accounting personnel. Attorney networks are unable to verify requested payment legitimacy, provide inaccurate reporting to debt owners of cost spent (if at all), and are further unable to protect against fraud, e.g., attorney network-paid costs that are not used for the requested purpose(s). Debt owners/banks/credit issuers have monies distributed throughout numerous entities and/or networks in a plethora of operating accounts, where such monies are often commingled client funds, lack visibility into actual costs spent versus amounts reimbursed, and lack cost control and effective cash management.

Various embodiments address reporting and/or tracking shortcomings associated with law firm account management, such as those described above. A centralized management entity can provide a centralized account for reimbursement entities from which payments to law firms/attorney networks can be made. Funds need not ever be actually possessed by law firms and/or attorney networks. Costs can be verified/validated, and full and real or near real-time reporting/tracking/auditing capabilities at varying levels, e.g., consumer account levels, can be achieved regardless of current status.

Various embodiments are described herein with respect to law firms, attorney networks, and reimbursement entities that can reimburse law firms and/or attorney networks for payments made on behalf of law firm clients. However, it should be understood that the systems and methods described herein may be adapted and/or applied to other contexts, for example, in the auto repair insurance context.

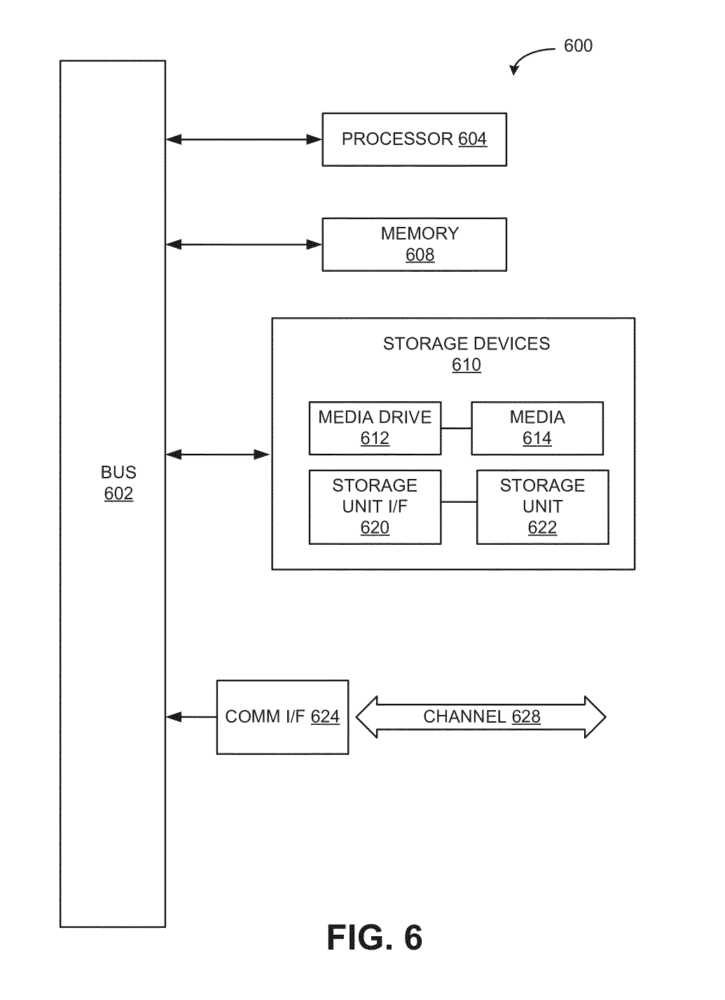

As used herein, the term module might describe a given unit of functionality that can be performed in accordance with one or more embodiments of the present application. As used herein, a module might be implemented utilizing any form of hardware, software, or a combination thereof. For example, one or more processors, controllers, ASICs, PLAs, PALs, CPLDs, FPGAs, logical components, software routines or other mechanisms might be implemented to make up a module. In implementation, the various modules described herein might be implemented as discrete modules or the functions and features described can be shared in part or in total among one or more modules. In other words, as would be apparent to one of ordinary skill in the art after reading this description, the various features and functionality described herein may be implemented in any given application and can be implemented in one or more separate or shared modules in various combinations and permutations. Even though various features or elements of functionality may be individually described or claimed as separate modules, one of ordinary skill in the art will understand that these features and functionality can be shared among one or more common software and hardware elements, and such description shall not require or imply that separate hardware or software components are used to implement such features or functionality.

Where components or modules of the application are implemented in whole or in part using software, in one embodiment, these software elements can be implemented to operate with a computing or processing module capable of carrying out the functionality described with respect thereto. One such example computing module is shown in FIG. 6. Various embodiments are described in terms of this example-computing module 600. After reading this description, it will become apparent to a person skilled in the relevant art how to implement the application using other computing modules or architectures.

Referring now to FIG. 6, computing module 600 may represent, for example, computing or processing capabilities found within a desktop, laptop, notebook, and tablet computers; hand-held computing devices (tablets, PDA's, smart phones, cell phones, palmtops, etc.); workstations or other devices with displays; servers; or any other type of special-purpose or general-purpose computing devices as may be desirable or appropriate for a given application or environment. Computing module 600 might also represent computing capabilities embedded within or otherwise available to a given device. For example, a computing module might be found in other electronic devices such as, for example navigation systems, portable computing devices, and other electronic devices that might include some form of processing capability.

Computing module 600 might include, for example, one or more processors, controllers, control modules, or other processing devices, such as a processor 604. Processor 604 might be implemented using a general-purpose or special-purpose processing engine such as, for example, a microprocessor, controller, or other control logic. In the illustrated example, processor 604 is connected to a bus 602, although any communication medium can be used to facilitate interaction with other components of computing module 600 or to communicate externally.

Computing module 600 might also include one or more memory modules, simply referred to herein as main memory 608. For example, preferably random access memory (RAM) or other dynamic memory, might be used for storing information and instructions to be executed by processor 604. Main memory 608 might also be used for storing temporary variables or other intermediate information during execution of instructions to be executed by processor 604. Computing module 600 might likewise include a read only memory (“ROM”) or other static storage device coupled to bus 602 for storing static information and instructions for processor 604.

The computing module 600 might also include one or more various forms of information storage mechanism 610, which might include, for example, a media drive 612 and a storage unit interface 620. The media drive 612 might include a drive or other mechanism to support fixed or removable storage media 614. For example, a hard disk drive, a solid state drive, a magnetic tape drive, an optical disk drive, a CD or DVD drive (R or RW), or other removable or fixed media drive might be provided. Accordingly, storage media 614 might include, for example, a hard disk, an integrated circuit assembly, magnetic tape, cartridge, optical disk, a CD or DVD, or other fixed or removable medium that is read by, written to or accessed by media drive 612. As these examples illustrate, the storage media 614 can include a computer usable storage medium having stored therein computer software or data.

In alternative embodiments, information storage mechanism 610 might include other similar instrumentalities for allowing computer programs or other instructions or data to be loaded into computing module 600. Such instrumentalities might include, for example, a fixed or removable storage unit 622 and an interface 620. Examples of such storage units 622 and interfaces 620 can include a program cartridge and cartridge interface, a removable memory (for example, a flash memory or other removable memory module) and memory slot, a PCMCIA slot and card, and other fixed or removable storage units 622 and interfaces 620 that allow software and data to be transferred from the storage unit 622 to computing module 600.

Computing module 600 might also include a communications interface 624. Communications interface 624 might be used to allow software and data to be transferred between computing module 600 and external devices. Examples of communications interface 624 might include a modem or softmodem, a network interface (such as an Ethernet, network interface card, WiMedia, IEEE 802.XX or other interface), a communications port (such as for example, a USB port, IR port, RS232 port Bluetooth® interface, or other port), or other communications interface. Software and data transferred via communications interface 624 might typically be carried on signals, which can be electronic, electromagnetic (which includes optical) or other signals capable of being exchanged by a given communications interface 624. These signals might be provided to communications interface 624 via a channel 628. This channel 628 might carry signals and might be implemented using a wired or wireless communication medium. Some examples of a channel might include a phone line, a cellular link, an RF link, an optical link, a network interface, a local or wide area network, and other wired or wireless communications channels.

In this document, the terms “computer program medium” and “computer usable medium” are used to generally refer to transitory or non-transitory media such as, for example, memory 608, storage unit 622, media 614, and channel 628. These and other various forms of computer program media or computer usable media may be involved in carrying one or more sequences of one or more instructions to a processing device for execution. Such instructions embodied on the medium, are generally referred to as “computer program code” or a “computer program product” (which may be grouped in the form of computer programs or other groupings). When executed, such instructions might enable the computing module 600 to perform features or functions of the present application as discussed herein.

Although described above in terms of various exemplary embodiments and implementations, it should be understood that the various features, aspects and functionality described in one or more of the individual embodiments are not limited in their applicability to the particular embodiment with which they are described, but instead can be applied, alone or in various combinations, to one or more of the other embodiments of the application, whether or not such embodiments are described and whether or not such features are presented as being a part of a described embodiment. Thus, the breadth and scope of the present application should not be limited by any of the above-described exemplary embodiments.

Terms and phrases used in this document, and variations thereof, unless otherwise expressly stated, should be construed as open ended as opposed to limiting. As examples of the foregoing: the term “including” should be read as meaning “including, without limitation” or the like; the term “example” is used to provide exemplary instances of the item in discussion, not an exhaustive or limiting list thereof; the terms “a” or “an” should be read as meaning “at least one,” “one or more” or the like; and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that may be available or known now or at any time in the future. Likewise, where this document refers to technologies that would be apparent or known to one of ordinary skill in the art, such technologies encompass those apparent or known to the skilled artisan now or at any time in the future.

The presence of broadening words and phrases such as “one or more,” “at least,” “but not limited to” or other like phrases in some instances shall not be read to mean that the narrower case is intended or required in instances where such broadening phrases may be absent. The use of the term “module” does not imply that the components or functionality described or claimed as part of the module are all configured in a common package. Indeed, any or all of the various components of a module, whether control logic or other components, can be combined in a single package or separately maintained and can further be distributed in multiple groupings or packages or across multiple locations.

Additionally, the various embodiments set forth herein are described in terms of exemplary block diagrams, flow charts and other illustrations. As will become apparent to one of ordinary skill in the art after reading this document, the illustrated embodiments and their various alternatives can be implemented without confinement to the illustrated examples. For example, block diagrams and their accompanying description should not be construed as mandating a particular architecture or configuration.

What is claimed is:

1. A non-transitory computer-readable medium having computer executable program code embodied thereon, the computer executable program code configured to cause a computer system to:
establish and maintain a payor account;
receive a request for payment of a legal services-related fee;
validate amount of the payment of the legal services-related fee;
issue a transaction ID for the payment of the legal services-related fee; and
associate the transaction ID with the payment of the legal services-related fee the payment of the legal services-related fee being funded through the payor account.

2. The non-transitory computer-readable medium of claim 1, wherein the payment comprises one of a printable check, a credit card account number, and an automated clearinghouse payment.

3. The non-transitory computer-readable medium of claim 1, wherein the payor account is established and maintained via a centralized management entity.

4. The non-transitory computer-readable medium of claim 1, wherein the computer executable program code is configured to further cause the computer system to remit a reimbursement payment to a legal entity as reimbursement for the payment of the legal services-related fee based upon validation of the legal services-related fee by comparing the legal services-related fee against a cost and fee schedule database, the cost and fee schedule database having been verified upon new law firm provisioning within the computer system.

5. The non-transitory computer-readable medium of claim 1, wherein the computer executable program code configured to cause the computer system to validate the amount of the payment further causes the computer system to request one or more documents with which the request for payment of the legal services-related fee is verified.

6. The non-transitory computer-readable medium of claim 1, wherein the computer executable program code is configured to further cause the computer system to track case one or more legal activities associated with the legal services-related fee.

7. The non-transitory computer-readable medium of claim 6, wherein the computer executable program code is configured to further cause the computer system to report costs spent by a legal entity to be paid from the payor account.

8. The non-transitory computer-readable medium of claim 7, wherein the computer executable program code configured to further cause the computer system to report costs spent by a legal entity performs the reporting of costs based upon at least one of jurisdictional parameters, comparison to one or more other legal entities, and one or more other attorney network entities.

9. The non-transitory computer-readable medium of claim 1, wherein the computer executable program code is configured to further cause the computer system to generate an exception report pursuant to remittance of the reimbursement payment to the legal entity as reimbursement for the payment of the legal services-related fee without validation of the amount of the payment of the legal services-related fee.

10. The non-transitory computer-readable medium of claim 1, wherein the computer executable program code is configured to further cause the computer system to remit payment directly to an entity to which the payment of the legal services-related fee is directed.

11. The non-transitory computer-readable medium of claim 1, wherein the computer executable program code is configured to further cause the computer system to generate a report for at least one of a debt owner absorbing a cost of the payment of the legal services-related fee and an attorney network covering the cost of the payment of the legal services-related fee.

12. A method, comprising:
transmitting a payment request to a centralized management entity, wherein the payment request is associated with payment of a legal services-related fee;
receiving a transaction ID associated with the payment request from the centralized management entity;
issuing a payment mechanism, wherein funds for the payment mechanism are paid out from a reimbursement account of at least one of a debt owner and an attorney network entity, and wherein the payment mechanism is issued only after verification of the legal services-related fee; and
remitting the payment for the legal services-related fee to a legal service provider providing a service for which the payment of the legal services-related fee is required.

13. The method of claim 12, wherein the payment mechanism comprises one of a printable check, a credit card account number, and an automated clearinghouse payment.

14. The method of claim 12, wherein the credit card account number comprises a time-limited one-time use credit card account number.

15. The method of claim 12, wherein the payment mechanism is issued in compliance with one or more payment requirements.

16. The method of claim 12, further comprising transmitting at least one validation document in evidencing an amount of the payment of the legal services-related fee.

17. A system, comprising:
a payment gateway configured to receive a payment request from a requesting entity, and issue a validated payment mechanism to the requesting entity via at least one of a reimbursement entity and an intermediary, the validated payment being funded by a reimbursement entity account maintained at the system;
a database comprising relevant fee schedules in accordance with which the validated payment is made for validating an amount of the payment request and tracking information comprising relevant data indicative of and associated with the validated payment mechanism and at least one of the requesting entity, the reimbursement entity, and the intermediary; and
a reporting module configured to track events associated with the validated payment mechanism beginning from receipt of the payment request through issuance of the validated payment mechanism.

18. The system of claim 17, wherein a cost management entity operatively associated with the payment gateway obtains copies of documents for which the payment request is associated, the system validating the payment request to be commensurate with the copies of the documents.

19. The system of claim 17, further comprising one or more collections systems for at least one of suspending or temporarily disabling receipt of the payment request pursuant to instructions from at least one of bank and debt owner associated with the requesting entity.

20. The system of claim 17, further comprising an intermediary system residing between the requesting entity and one of a debt owner, attorney network, or bank, wherein the intermediary system effectuates at least one of integration and porting of accounts associated with the requesting entity.
